(19) United States
(12) Patent Application Publication
(10) Pub. No.: US 2017/0025680 A1
(43) Pub. Date: Jan. 26, 2017

(54) ELECTRODE MATERIAL AND METHOD FOR MANUFACTURING SAME

(71) Applicant: Robert Bosch GmbH, Stuttgart (DE)

(72) Inventors: Ulrich Sauter, Karlsruhe (DE); Joerg Thielen, Stuttgart (DE); Bernd Schumann, Rutesheim (DE)

(21) Appl. No.: 15/202,237

(22) Filed: Jul. 5, 2016

(30) Foreign Application Priority Data
Jul. 8, 2015 (DE) 102015212815.6

(51) Int. Cl. H01M 4/60; H01M 10/052; H01M 4/04; H01M 4/62; H01M 4/66

(52) U.S. Cl. CPC H01M 4/604; H01M 4/625; H01M 4/661; H01M 4/0485; H01M 10/052; H01M 2004/028

(57) ABSTRACT

A battery electrode for battery cells is described, in particular, a cathode, having a contactor for establishing an electrical contact with an electrical conductor and an electrode-active material, the electrode-active material having a surface structuring.

### CROSS REFERENCE

The present application claims the benefit under 35 U.S.C. §119 of German Patent Application No. DE 102015212815.6 filed on Jul. 8, 2015, which is expressly incorporated herein by reference in its entirety.

### FIELD

The present invention relates to an electrode material, an electrode and a battery cell containing same, as well as a method for the manufacture and use thereof.

### BACKGROUND INFORMATION

In order to manufacture batteries having a significantly higher energy density, present research is directed toward lithium-sulfur battery technology. If the cathode of a lithium-sulfur battery cell were made exclusively of elemental sulfur, theoretically an energy content of more than 1,000 Wh/kg could be achieved. However, elemental sulfur is neither ionic nor electrically conductive, so that additives are added to the cathode, which considerably reduce the theoretical value. In addition, elemental sulfur is traditionally reduced to soluble polysulfides as a lithium-sulfur cell is discharged. The polysulfides may diffuse in areas of the battery cell, such as the anode area, where they are no longer capable of participating in the electrochemical reaction of the subsequent charge/discharge cycles. Therefore, in practice, sulfur utilization and thus the energy density of lithium-sulfur battery cells is much lower and presently estimated to be between 400 Wh/kg and 600 Wh/kg.

Different concepts exist for increasing sulfur utilization. Nazar et al. describe in Nature Materials, vol. 8, June 2009, 500-506 that small carbon tubes favor retention of polysulfides in the cathode area, promoting, at the same time, sufficient electrical conductivity.

Wang et al. describe in Advanced Materials, 14, 2002, No. 13-14, pp. 963-965 and Advanced Functional Materials, 13, 2003, No. 6, pp. 487-492 and Yu et al. describe in Journal of Electroanalytical Chemistry, 573, 2004, 121-128 and Journal of Power Sources 146, 2005, 335-339 another technology in which polyacrylonitrile (in short PAN) is heated with an excess of elemental sulfur, the sulfur being cyclized to a polymer having a conjugated n-system while forming H₂S polyacrylonitrile on the one hand, and being bound in the cyclized matrix on the other.

Furthermore, a method for manufacturing a polyacrylonitrile-sulfur composite material is described in German Patent Application No. DE 10 2011 075 053 A1. In this method, polyacrylonitrile is converted to a polyacrylonitrile-sulfur composite material using sulfur, at least temporarily in the presence of a suitable catalyst.

The manufacture of battery electrodes, in particular, of cathodes, is typically carried out using a thick-layer method. Particles of an electrode-active material containing additives for increasing the electrical conductivity, such as carbon black or graphite, are reacted, and furthermore processed with a polymer binder and, if necessary, with a solvent, to a paste. This paste is applied in a coating process to a metal sheet, which is later used as a current collector on the corresponding battery electrode.

This coating is then dried, the solvent being removed by evaporation. The dried electrode is then typically compressed in a calender, provided with a suitable separator and a counter-electrode, and processed to a cell stack. This may have a wound or stacked form and it may form a battery cell. Finally, the battery cell is filled with a liquid electrolyte, which is absorbed into the porous electrodes due to capillary forces within the battery cell stack, and fully wets the pores.

If a polymer electrolyte is used instead of a liquid electrolyte, it also takes on most of the function of a corresponding binder in the electrode. Also in this case, an appropriate paste is applied to the thin current-removing sheet, which in the case of a cathode is made of aluminum, for example, and is suitably dried or compressed.

The type of manufacturing process causes the electrode to be made up of suitable particles, which are present in a paste statistically distributed and between which there are highly wound conduction paths, which are available to the liquid or polymer electrolytes. This, however, makes the effective ion conductivity of the battery electrode thus manufactured considerably less than what would correspond to a conductivity of the free electrolyte weighted with the percent by volume of the electrolyte in the electrode.

### SUMMARY

In contrast, according to the present invention, an electrode material, an electrode, and a battery cell containing the electrode material, as well as a method for its manufacture and its use are provided.

The battery electrode according to the present invention includes, in addition to a contactor for establishing an electrical contact of the battery electrode with an electrical conductor, an electrode-active material having a surface structuring. As defined herein, a surface structuring is understood as a structure that is mechanically impressed on a layer of the electrode-active material. By providing a surface structuring of the electrode-active material, directional conductive paths are artificially produced in the electrode, which are available to a liquid, polymer or ceramic electrolyte during later operation, thus supporting or improving the transport and diffusion processes, in particular, of electrochemically active species, necessary for the operation of a battery cell containing the battery electrode.

In this way, transport resistances regarding electrical resistances within the battery cell are minimized, and the transport and diffusion processes of electrochemically active species within the electrode are optimized. This also results in a reduction of the electrical resistance with respect to the battery electrode and battery cell according to the present invention.

It may be advantageous if the surface structuring of the electrode active material takes place in the form of grooves, channels, or recesses, structures corresponding to columns or lamellas, for example, being produced on the surface of the electrode active material. In relation to a particularly good ion conductivity of the channels remaining between columns or lamellas for access of an electrolyte during the later operation of the battery electrode, it is advantageous if the footprint of the columns or lamellas has a length to width ratio of a corresponding lamella or column between 20 to 1 and 5 to 1.

Furthermore, it may be advantageous in this respect if the width of a corresponding column or lamella is established from 2 μm to 20 μm, in particular, in the range of 5 μm to 10 μm. It is furthermore preferred if the lamellas or columns have a height in the range of 20 μm to 150 μm, in particular, in the range of 50 μm to 120 μm.

It is furthermore preferred if the distance between two columns or lamellas is approximately 30% to 100% of their width. In addition, it is advantageous if the columns or lamellas are arranged in rows in relation to one another, the distance between two columns or lamellas within a row being 2 μm to 20 μm.

It is furthermore preferred if the columns or lamellas of a row are offset in relation to the columns or lamellas of a neighboring row by approximately 20% to 50% of the length of the columns or lamellas of this type in the direction of the row. In this way flow channels are made available between the columns or lamellas, which, by their cross-section and arrangement, allow optimum access of ion-containing electrolytes, for example, to the entire surface of the columns or lamellas of the electrode-active material provided with a surface structure.

It may be furthermore advantageous if the electrode-active material has sufficient mechanical inherent stability. For this purpose, the electrode-active material layer has a first area provided with the surface structure and a second, unstructured area, onto which the first area is applied. It is particularly advantageous if the unstructured second area as base area of the electrode-active material layer has a layer thickness of 2 μm to 20 μm.

According to a particularly advantageous specific embodiment of the present invention, the battery electrode as electrode-active material includes a polyacrylonitrile, in particular, a sulfur-modified polyacrylonitrile (SPAN). In this way, battery cells that due to the electrochemical properties of SPAN have energy densities of more than 400 Wh/kg may be made available.

The battery cell according to the present invention may be advantageously used for storing electrical energy, for example, in battery modules. These battery modules may be used in computers, in mobile applications such as, for example, in mobile telecommunication devices or in laptops, in electric vehicles, hybrid vehicles or plug-in hybrid vehicles, as well as in stationary storage systems for storing, for example, regeneratively produced electrical energy.

### BRIEF DESCRIPTION OF THE DRAWINGS

Advantageous specific embodiments of the present invention are illustrated in the figures and explained in greater detail below.

FIG. 1 shows the schematic representation of a battery cell according to a first advantageous specific embodiment of the present invention.

FIG. 2 shows the schematic representation of a surface of a battery electrode according to the present invention.

FIG. 3A and 3B shows the schematic representation of a surface structuring of the battery electrode shown in FIG. 2, in top view.

FIG. 4 shows the schematic representation of the battery electrode illustrated in FIG. 2 in a sectional representation.

FIG. 5 shows the schematic representation of a device for manufacturing a battery electrode according to FIG. 2.

### DETAILED DESCRIPTION OF EXAMPLE EMBODIMENTS

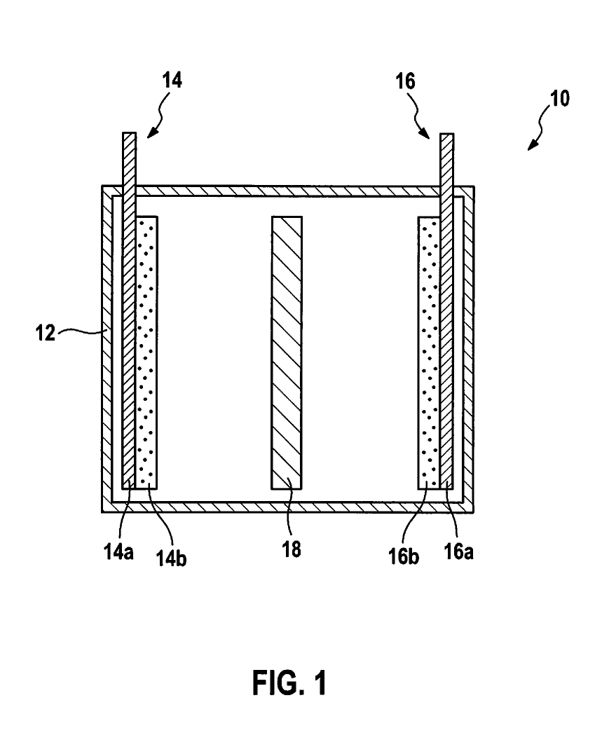

FIG. 1 schematically shows a battery cell containing a battery electrode according to the present invention. Battery cell 10 includes a housing 12, containing a first electrode 14, in particular, an anode, and a second electrode 16, in particular, a cathode. First electrode 14 includes a current collector 14a made of metal, in particular, for electrical contacting of first electrode 14 using a first contact (not shown in FIG. 1) of battery cell 10, and an electrode-active material 14b, on which the electrochemical processes occurring during the operation of battery cell 10 run, for example, in the form of metallic lithium. Current collector 14a is made of copper, for example, and covers the entire surface or a portion of electrode-active material 14b, for example.

Furthermore, second electrode 16 includes a second current collector 16a, which is also made of metal, in particular, and is used for electrically contacting second electrode 16 using a second electrical contactor (not shown in FIG. 1) of the battery cell. In addition, second electrode 16 includes a second electrode-active material 16b, on which the additional electrochemical processes occurring during the operation of battery cell 10 run with respect to the electrochemical processes occurring on first electrode material 14b. The first and second current collectors 14a and 14b are led out of housing 12 of battery cell 10, for example, for contacting battery cell 10.

Battery cell 10 furthermore includes a separator 18, for example, which ensures the ionic conductivity within battery cell 10, while preventing an electrical contact of the two electrodes 14, 16. When a suitable solid electrolyte and/or a suitable dendrite preventing protective layer is/are used and when a metallic first electrode-active material 14a, in particular, made of lithium, is used within battery cell 10, a traditional separator 18 may be omitted.

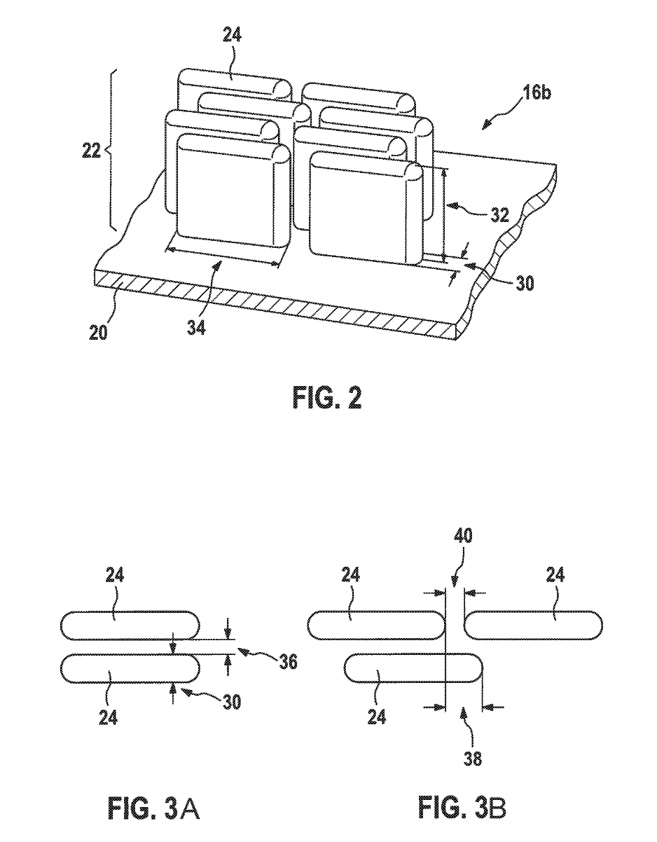

FIG. 2 shows second electrode 16 according to the present invention in detail. The same reference numerals denote the same components as in FIG. 1. Second electrode 16 includes a current collector 16a (not shown) and an electrode-active material 16b. Electrode-active material 16b is divided into base area 20, which is unstructured, for example, and a structured area 22 provided with surface structuring. Structured area 22 includes, in this example, columns or lamellas, for example, made of electrode-active material, which are perpendicular to the direction of extension of a large surface of second electrode 16, raised thereon.

Columns or lamellas 24 are arranged in one-dimensional rows, for example. It is, however, also possible to distribute, i.e., arrange columns or lamellas 24 in a different, two-dimensional geometric or statistical pattern on the large surface of second electrode 16. Lamellas or columns 24 are preferably made of a polyacrylonitrile-sulfur composite material (SPAN). In the present exemplary embodiment, for example, second electrode 16, used as a cathode, thus includes SPAN as electrode-active material and may be used in alkali-sulfur battery cells, in particular, in lithium-sulfur battery cells. Second electrode 16 has straight, unwound conductor paths, and thus improved electrochemical properties, compared to electrodes manufactured using a paste process. This is true in particular, in relation to the maximum rate capability of battery cell 10, for given intrinsic material properties and given electrode charge, since the transport paths are directional and thus shorter overall. In addition, the structuring is selected in such a way that the percent by volume of the electrolyte or polymer electrolyte in relation to the volume of second electrode 16 is relatively small, i.e., minimized, in that, due to its structuring, it is used only where ion conductivity is needed.

Battery cell 10 according to the present invention itself thus has an increased volumetric energy density compared to battery cells having unstructured electrodes.

Structured area 22 of electrode-active material 16b provides, in particular, a preferably unhindered access of an electrolyte in contact with electrode-active material 16b, a preferably minimal diffusion resistance regarding the supply and removal of lithium ions, and thus a highly enhanced lithium ion conductivity is achieved. In order to ensure this, columns or lamellas 24 are positioned on the large surface of electrode-active material 16b following fluidic criteria. This refers to the dimensioning of columns or lamellas 24 themselves and to the selected distances between columns and lamellas 24.

It is therefore preferred if columns and lamellas 24 have a width 30 in the range of 2 μm to 20 μm, in particular, from 5 μm to 10 μm. Furthermore, it is preferred if columns or lamellas 24 have a height 32 of 20 μm to 150 μm, for example, in particular, of 50 μm to 120 μm. In addition, it is preferred if lamellas or columns 24 have a height 32 having a certain ratio to the width of the columns or lamellas 24. Height 32 of the lamellas or columns 24 is therefore selected in the height 32 to width 30 ratio between 20 to 1 and 5 to 1.

As stated above, columns or lamellas 24 may be arranged in rows that are preferably parallel to each other. Columns or lamellas 24 may be positioned in rows in relation to each other in such a way that there is no offset between the individual lamellas and columns with respect to neighboring columns and lamellas 24 of another row. Such a specific embodiment is illustrated in FIG. 3a, where distance 36 between two rows formed by columns or lamellas 24 is 0.3 to 1 times width 30 of columns or lamellas 24.

It is, however, also possible to design the rows formed by columns or lamellas 24 using an offset of the columns or lamellas 24 with respect to each other. Such a specific embodiment is shown, for example, in FIG. 3b, where the illustrated columns or lamellas 24 have a geometric offset of 20% to 50% of length 34 of columns or lamellas 24 with respect to the columns or lamellas of a neighboring row. The distance between two neighboring columns or lamellas 24 is characterized by reference numeral 36, and the offset of the two columns or lamellas 24 to each other by reference numeral 38. Furthermore, columns or lamellas 24 within a row have distance 40 to each other of 2 μm to 20 μm, for example, regardless, for example, of whether or not there is an offset of the rows formed by columns or lamellas 24.

Columns or lamellas 24 contain a polyacrylonitrile-sulfur composite material (SPAN) as electrode-active material, to which preferably also an additive such as carbon black and/or graphite is added to increase its electrical conductivity. Furthermore, ceramic electrolytes such as sulfide glasses, such as argyrodite, may be provided between columns and lamellas 24. The argyrodite particles used have, for example, a particle distribution d₅₀, which preferably corresponds to one-tenth of the smallest dimension between the individual SPAN structures. The argyrodite particles are located between the SPAN structures, for example, and function as an electrolyte. Having been applied, it is further compressed, for example. As an alternative, mixtures of polymer electrolyte and argyrodite may also be used as an electrolyte.

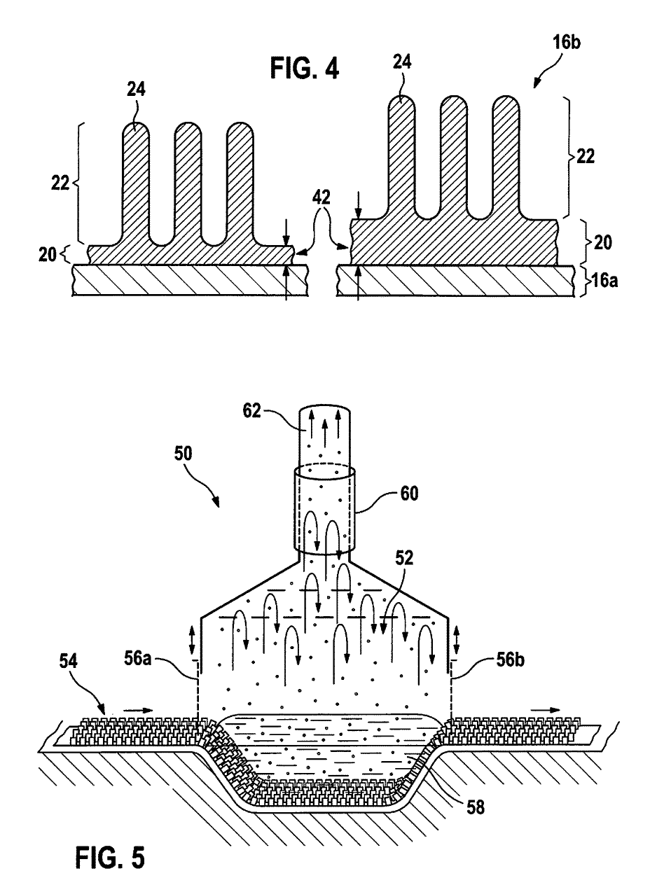

FIG. 4 schematically shows a sectional view of second electrode-active material 16b of second electrode 16. Again, the same reference numerals denote the same components as in FIGS. 1 through 3B.

Electrode-active material 16b includes a generally unstructured base area 20 and a structured area 22 provided with surface structuring. Base area 20 is preferably made of the same or comparable material as structured area 22. In an alternative specific embodiment, the content of additive for increasing electrical conductivity in base area 20 may be higher than in structured area 22. Layer thickness 42 of base area 20 may be 2 μm to 20 μm, for example. In a particularly preferred specific embodiment, the layer thickness of base area 20 corresponds to that of second current collector 16a. The latter may be designed, for example, in the form of a rough aluminum foil. FIG. 4 shows two specific embodiments having different layer thicknesses of base area 20.

The manufacture of second battery electrode 16 according to the present invention starts with a polyacrylonitrile layer designed as a foil, for example. This polyacrylonitrile foil includes, for example, a layer thickness of 30 μm to 150 μm, preferably from 50 μm to 120 μm. The polyacrylonitrile foil is produced, for example, by casting a polyacrylonitrile solution in a suitable solvent such as NMP or DMF into a suitable negative mask and subsequently removing the solvent via a suitable thermal process. As an alternative, instead of a polyacrylonitrile solution, an initial mixture of acrylonitrile in a suitable solvent is used, and a suitable polymerization initiator is added. In order to produce a polyacrylonitrile foil, after casting the acrylonitrile solution into a suitable negative mask, the radical polymerization of the acrylonitrile to polyacrylonitrile is initiated. Finally, the polyacrylonitrile foil provided with surface structuring 22 is removed from the mask. It may be subsequently transferred to an electrically conductive substrate such as aluminum, for example, or an aluminum foil, the aluminum foil then taking on the function of a current collector 16a.

Alternative options for manufacturing a polyacrylonitrile foil provided with surface structuring include, for example, starting with an unstructured thickened polyacrylonitrile paste, which is then structured, for example, with the aid of two heated rotating rollers, of which at least one has a suitable surface structuring as negative. Subsequently the solvent still present is thermally removed and the polyacrylonitrile is suitably hardened as described above.

Another option for manufacturing a suitably structured polyacrylonitrile foil includes using a suitable fine granular polyacrylonitrile powder as starting material, whose particle size distribution d₅₀ is substantially smaller than the typical dimensions of the surface structuring of the polyacrylonitrile foil to be produced later. The polyacrylonitrile powder is pressed in a negative mask, with a suitable binder optionally added, so that a polyacrylonitrile foil provided with a surface structure is directly obtained.

Further structuring options include a mechanical surface processing of polyacrylonitrile foils, such as treatment with laser, for example, via an etching process such as plasma etching, for example, via a mask prestructured using a photoresist, or by mechanical cutting.

In a subsequent process step, a polyacrylonitrile foil provided with surface structuring is converted into a polyacrylonitrile-sulfur composite material (SPAN).

This takes preferably place in a through-type furnace such as illustrated in FIG. 5, for example. Through-type furnace 50 includes a furnace space 52, into which prestructured polyacrylonitrile foil 54 enters through a lock 56a on the left side of furnace space 52 and, leaving through a second lock 56b on the right side of furnace space 52. Inside furnace space 52, prestructured polyacrylonitrile foil 54 is brought into contact with liquid sulfur 58. The reaction temperature is between 300° C. and 600° C., in particular, between 400° C. and 500° C. for a reaction time of preferably 30 to 560 minutes, in particular, 60 to 240 minutes.

Since at the selected reaction temperature there is a significant sulfur vapor pressure within furnace space 52, through-type furnace 50 also includes a condenser 60 for condensing the elemental gaseous sulfur contained in the exhaust air, and an exhaust gas extractor 62, with the aid of which the excess gases formed, in particular, hydrogen sulfide, may be removed from the inside of the furnace. In a further process step, the surface of the SPAN foil thus obtained is coated, for example, with an additive such as carbon black or graphite for increasing the electrical conductivity.

An alternative specific embodiment provides for adding an additive for increasing the electrical conductivity already to the solution of a polyacrylonitrile for producing a polyacrylonitrile foil, whereby it is available in the entire polyacrylonitrile foil material. Furthermore, it is also conceivable to add elemental sulfur to the polyacrylonitrile solution for producing a polyacrylonitrile foil. This has the advantage that after structuring the polyacrylonitrile foil, during the subsequent reaction with sulfur within the above-described furnace, the reactive surface between polyacrylonitrile and sulfur is increased and a higher level of covalently bound sulfur is achieved.

Polyacrylonitrile is reacted with an excess of elemental sulfur preferably under an inert gas atmosphere, for example, under nitrogen or argon in furnace space 52 and using normal pressure or considerably higher pressure under sulfur vapor or adding liquid sulfur.

The SPAN foil or SPAN structure thus obtained, after leaving the furnace, is washed with a nonpolar solvent such as toluene, for example, for removing the excess sulfur not covalently bound to the composite. Alternatively, most of the excess elemental and not covalently bound sulfur may also be removed under a thermal partial vacuum, followed by washing as described above.

For installing the battery electrode thus obtained, which includes electrode-active material 16b provided with a surface structure, and a current conductor 16a, in a battery cell, the polyacrylonitrile-sulfur composite material provided with a surface structure is saturated with an electrolyte in the cavities formed during structuring before it is installed. This is preferably a polymer electrolyte, for example, a polyethylene oxide (PEO) or a polyethylene oxide derivative, mixed with a conductive salt such a lithium-trifluoromethane sulfonyl imide (LITFSI).

In particular, organic electrolytes having high transfer numerals (close to 1), known as polyelectrolytes or also organic single-ion conductors (organic SIC), in which anions are covalently bound to a polymer ridge and only the electrochemically active cation species in the form of lithium ions is mobile, are preferred for filling the intermediate spaces.

Ceramic electrolytes, such as sulfide glasses, may also be used for filling the intermediate spaces of the structured SPAN electrode. Mixtures of the above-described electrolytes are also conceivable. In this case mixtures of materials whose transport properties are similar are preferred, for example, when both materials have high transfer numerals. Mixtures of polymers, organic SIC, and sulfide glasses such as argyrodite may be mentioned here as examples.

It is also possible to fill the intermediate spaces, at least partially, with a gel electrolyte including a polymer in the form of PEO with a conductive salt or an organic SIC and an organic solvent.

The battery electrode according to the present invention and the underlying electrode-active material may be advantageously used, with polymer and/or ceramic ion conductors as electrolytes in lithium-sulfur batteries. Battery cells of this type are used, for example, in mobile consumer devices such as telecommunication devices or computers, in electric vehicles, hybrid vehicles, and plug-in hybrid vehicles, as well as in systems for stationary storage of electrical energy, for example, regeneratively obtained electrical energy.

What is claimed is:

1. A battery electrode for battery cells, comprising:
a contactor for establishing an electrical contact with an electric conductor; and
an electrode-active material having a surface structuring.

2. The battery electrode as recited in claim 1, wherein the battery electrode is a cathode.

3. The battery electrode as recited in claim 1, wherein the surface structuring of the electrode-active material includes one of grooves, channels, or recesses, which are produced uniformly on the surface of the electrode-active material.

4. The battery electrode as recited in claim 1, wherein one of columns or lamellas are formed from electrode-active material as surface structuring of the electrode-active material.

5. The battery electrode as recited in claim 4, wherein footprints of one of the columns or lamellas have a length to width ratio of 20 to 1 to 5 to 1.

6. The battery electrode as recited in claim 4, wherein the one of the columns or lamellas have a width of 2 μm to 20 μm.

7. The battery electrode as recited in claim 6, wherein the width is 5 μm to 10 μm.

8. The battery electrode as recited in claim 4, wherein the one of the columns or lamellas have a height of 20 μm to 150 μm.

9. The battery electrode of claim 8, wherein the height is 50 μm to 120 μm.

10. The battery electrode as recited in claim 4, wherein the one of the columns or lamellas are arranged in rows, and a distance between two rows of the one of the columns or lamellas is 30% to 100% of the width of the respective columns or lamellas.

11. The battery electrode as recited in claim 4, wherein the one of the columns or lamellas are arranged in rows, and a distance between two columns or lamellas within a row is between 2 μm and 20 μm.

12. The battery electrode as recited in claim 4, wherein the one of the columns or lamellas are arranged in rows, and at least one of the rows is offset in relation to a neighboring row by 20% to 50% of a length of a column or lamella in a direction of the row.

13. The battery electrode as recited in claim 1, wherein the electrode-active material includes a structured surface area and an unstructured base area with respect to its layer thickness, the unstructured base area having a layer thickness of 2 μm to 20 μm.

14. The battery electrode as recited in claim 1, wherein the electrode-active material contains a polyacrylonitrile.

15. The battery electrode as recited in claim 1, wherein the electrode-active material contains a sulfur-modified polyacrylonitrile.

16. A method for manufacturing a battery electrode, comprising:
manufacturing a foil of an electrode-active material with a surface structuring at least on one surface; and
transferring the foil made of electrode-active material to an electrically conductive substrate and fixing the foil to the electrically conductive substrate.

17. The method as recited in claim 16, wherein the foil made of electrode-active material is manufactured by casting a liquid preform of the electrode-active material into a casting mold, the casting mold being provided with a structure, which results in a surface structuring of the electrode-active material foil to be produced.

18. The method as recited in claim 16, further comprising:
saturating the electrode-active material foil with a liquid or polymer electrolyte.

19. A method for manufacturing a battery electrode, comprising:
manufacturing a polyacrylonitrile foil with a surface structuring on at least one surface;
transferring the polyacrylonitrile foil to a flat electronically conductive substrate; and
subjecting a composite of the electrically conductive substrate and the polyacrylonitrile foil to a thermal treatment using liquid or gaseous sulfur to form a sulfur-modified polyacrylonitrile.

20. The method as recited in claim 19, further comprising:
providing the foil with an addition of a carbon black or graphite additive for increasing electrical conductivity of the foil.

21. The battery electrode as recited in claim 1, wherein the battery electrode is in a battery module for storing electrical energy in a computer.

22. The battery electrode as recited in claim 1, wherein the battery electrode is in a battery module for storing electrical energy in a mobile telecommunications device.

23. The battery electrode as recited in claim 1, wherein the battery electrode is in a battery module for storing electrical energy in an electric or hybrid vehicle.

24. The battery electrode as recited in claim 1, wherein the battery electrode is in a battery module for storing electrical energy in a stationary storage device for regeneratively obtained electrical energy.
